(19) United States
(12) Patent Application Publication
(10) Pub. No.: US 2014/0122680 A1
(43) Pub. Date: May 1, 2014

(54) INFORMATION PROCESSING APPARATUS AND METHOD, AND NON-TRANSITORY COMPUTER READABLE MEDIUM

(71) Applicant: FUJI XEROX CO., LTD., Tokyo (JP)

(72) Inventor: Akira Okamoto, kanagawa (JP)

(73) Assignee: FUJI XEROX CO., LTD., Tokyo (JP)

(21) Appl. No.: 13/898,076

(22) Filed: May 20, 2013

(30) Foreign Application Priority Data
Oct. 30, 2012 (JP) 2012-239352

(51) Int. Cl. H04L 12/24

(52) U.S. Cl. CPC H04L 41/12
USPC 709/223

(57) ABSTRACT

An information processing apparatus includes a physical interface, a memory, and a communication controller. The physical interface communicates with any of multiple networks. The memory stores identification information relating to a communication device connected to each network and network setting information corresponding to the network in association with each other. The communication controller controls, when identification information obtained via the physical interface is different from identification information associated with network setting information set in the physical interface, communication of the physical interface on the basis of network setting information associated with the obtained identification information.

### CROSS-REFERENCE TO RELATED APPLICATIONS

This application is based on and claims priority under 35 USC 119 from Japanese Patent Application No. 2012-239352 filed Oct. 30, 2012.

### BACKGROUND

### Technical Field

The present invention relates to an information processing apparatus and method and to a non-transitory computer readable medium.

### SUMMARY

According to an aspect of the invention, there is provided an information processing apparatus including a physical interface, a memory, and a communication controller. The physical interface communicates with any of multiple networks. The memory stores identification information relating to a communication device connected to each network and network setting information corresponding to the network in association with each other. The communication controller controls, when identification information obtained via the physical interface is different from identification information associated with network setting information set in the physical interface, communication of the physical interface on the basis of network setting information associated with the obtained identification information.

### BRIEF DESCRIPTION OF THE DRAWINGS

An exemplary embodiment of the present invention will be described in detail based on the following figures, wherein:

FIG. 1 is a diagram illustrating the hardware configuration of an image forming apparatus according to an exemplary embodiment of the invention;

FIG. 2 is a sequence diagram until an IP address is assigned to the image forming apparatus;

FIG. 3 is a functional block diagram of the image forming apparatus;

FIG. 4 is a diagram illustrating exemplary details stored in a setting information memory;

FIG. 5 is a flowchart illustrating a process executed by the image forming apparatus; and

FIG. 6 is a hardware block diagram according to a modification (4).

### DETAILED DESCRIPTION

An exemplary embodiment of the invention (hereinafter referred to as an “exemplary embodiment”) will be described in accordance with the drawings. In the exemplary embodiment, the case in which an information processing apparatus according to the exemplary embodiment is applied to an image forming apparatus will be described by way of example. The information processing apparatus may be realized with a computer such as a personal computer.

### 1. Hardware Configuration of Image Forming Apparatus

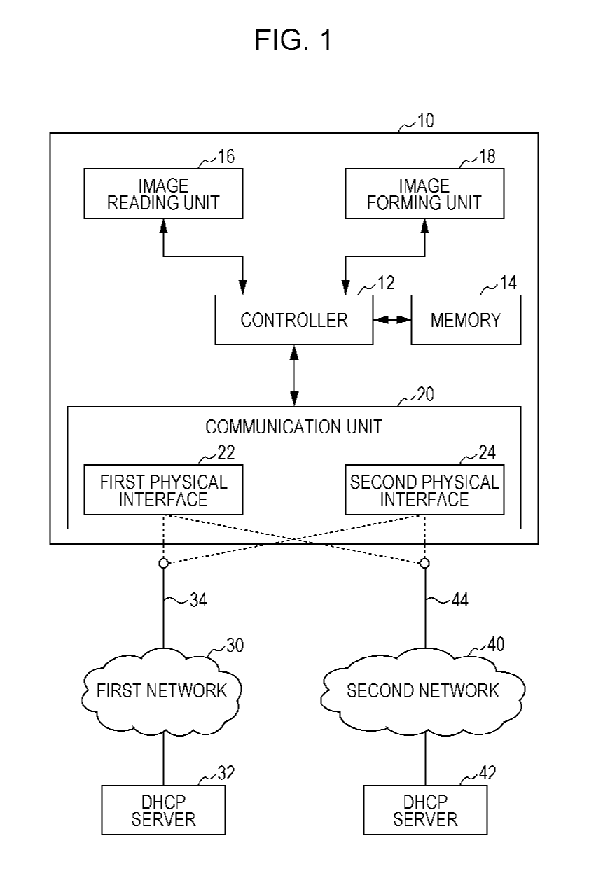

FIG. 1 is a diagram illustrating the hardware configuration of an image forming apparatus according to the exemplary embodiment. As illustrated in FIG. 1, an image forming apparatus 10 includes a controller 12, a memory 14, an image reading unit 16, an image forming unit 18, and a communication unit 20. The image forming apparatus 10 may further include an operation unit, a display, a power switch, and the like, besides the configuration illustrated in FIG. 1.

The controller 12 includes a central processing unit (CPU). The controller 12 executes a program stored in the memory 14 and controls each unit of the image forming apparatus 10.

The memory 14 includes various memories such as a hard disk and a random-access memory (RAM). The memory 14 is a storage medium that stores the program executed by the controller 12. Additionally, the memory 14 is also used as, for example, a work memory for the controller 12. Various memories are applicable as the memory 14. For example, the memory 14 may be realized with a storage device such as a semiconductor memory.

Alternatively, the program and various types of data described as being stored in the memory 14 in the exemplary embodiment may be obtained from an external device via the communication unit 20, or may be obtained from an external storage medium.

The image reading unit 16 includes a scanner or the like. By optically scanning an object to be scanned, such as a sheet, the image reading unit 16 generates an image of the object. The image forming unit 18 includes a printer or the like. On the basis of image data obtained from the image reading unit 16 or the communication unit 20, the image forming unit 18 forms an image on a recording medium (such as a sheet or a film).

The communication unit 20 includes a network interface card (NIC) or the like. The communication unit 20 performs wired or wireless data communication with an external device connected to the image forming apparatus 10. In the exemplary embodiment, the communication unit 20 includes multiple physical interfaces. Here, the case in which the communication unit 20 includes two physical interfaces (a first physical interface 22 and a second physical interface 24) will be described by way of example. However, the number of physical interfaces included in the communication unit 20 may by an arbitrary number.

The first physical interface 22 and the second physical interface 24 include connectors with a certain shape (slots for cables 34 and 44) and communicate with any of multiple networks (a first network 30 an a second network 40). The exemplary embodiment discusses the case in which the image forming apparatus 10 is connected to each of two networks. Alternatively, the number of networks connected to the image forming apparatus 10 may only necessarily be plural, and three or more networks may be connected to the image forming apparatus 10.

The first network 30 and the second network 40 are the Internet, an intranet, a next generation network (NGN), or the like. The first network 30 and the second network 40 are networks independent of each other and are not connected to each other. The first network 30 and the second network 40 communicate with each other by sending and receiving signals to and from each other.

As illustrated in FIG. 1, the first network 30 includes a Dynamic Host Configuration Protocol (DHCP) server 32, and the second network 40 includes a DHCP server 42. The DHCP servers 32 and 42 each assign an IP address in response to a request from a computer.

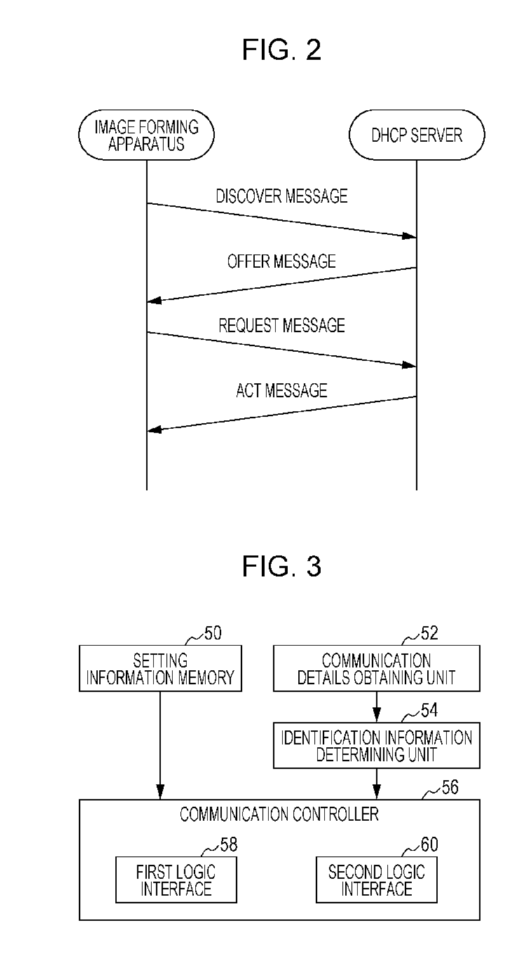

FIG. 2 is a sequence diagram until an IP address is assigned to the image forming apparatus 10. Here, the flow of a process in the case where the cable 34 is inserted into the connector of the first physical interface 22 will be described. As illustrated in FIG. 2, when the cable 34 is inserted into the connector of the first physical interface 22, the image forming apparatus 10 broadcasts a discover message to the entire first network 30 (broadcast address) in the same segment as the image forming apparatus 10. The discover message includes the media access control (MAC) address of the first physical interface 22.

Upon receipt of the discover message, the DHCP server 32 sends an offer message to the image forming apparatus 10. The offer message includes information of IP addresses usable by the image forming apparatus 10 (IP addresses that are not leased to other computers) and vendor unique information. The DHCP server 32 presents leasable IP addresses to the image forming apparatus 10.

Upon receipt of the offer message, the image forming apparatus 10 obtains the IP addresses included in the offer message. When multiple offer messages are received, the image forming apparatus 10 obtains the IP addresses included in the first received offer message. The image forming apparatus 10 sends a request message including the obtained IP addresses to the DHCP server 32.

Upon receipt of the request message, the DHCP server 32 assigns an IP address to the image forming apparatus 10 in accordance with the details of the request message. The DHCP server 32 controls the IP address assigned to the image forming apparatus 10 to be unusable by other computers. The DHCP server 32 sends, to the image forming apparatus 10, an act message indicating that the IP address is formally assigned. Upon receipt of the act message, the image forming apparatus 10 executes a process of setting the IP address in accordance with the details of the act message and controls communication thereafter.

The flow of a process in the case where the cable 44 is inserted into the connector of the second physical interface 24 is the same as the above process. It is only necessary to replace the description “first physical interface 22” with “second physical interface 24”, the description “first network 30” with “second network 40”, and the description “DHCP server 32” with “DHCP server 42”. The same process as the above process is executed when the cable 44 is inserted into the connector of the first physical interface 22 and when the cable 34 is inserted into the connector of the second physical interface 24.

Here, it is assumed that the first physical interface 22 and the second physical interface 24 include NICs whose types correspond to each other (such as NICs with the same communication standard), and have connectors (slots) with the same shape. Therefore, the cable 34 and the cable 44 may be inserted into either the first physical interface 22 or the second physical interface 24.

When a user disconnects the cables 34 and 44 from the image forming apparatus 10 and reinserts the cables 34 and 44 into the first physical interface 22 and the second physical interface 24, the cables 34 and 44 may be inserted into connectors different from those into which the cables 34 and 44 were originally inserted. For example, the cable 44 may be inserted into the connector of the first physical interface 22 although the first physical interface 22 is set for the first network 30. Similarly, the cable 34 may be inserted into the connector of the second physical interface 24 although the second physical interface 24 is set for the second network 40.

In the exemplary embodiment, in response to such a wrong connection, network setting information corresponding to a currently connected network is automatically assigned to each physical interface. This configuration will be described in detail hereinafter.

### 2. Functions Realized in Image Forming Apparatus

FIG. 3 is a functional block diagram of the image forming apparatus 10. As illustrated in FIG. 3, the image forming apparatus 10 includes a setting information memory 50, a communication details obtaining unit 52, an identification information determining unit 54, and a communication controller 56. The functions illustrated in FIG. 3 are realized by executing, by the controller 12, the program stored in the memory 14. In the exemplary embodiment, among the functions illustrated in FIG. 3, the communication details obtaining unit 52, the identification information determining unit 54, and the communication controller 56 are realized mostly by the controller 12, and the setting information memory 50 is realized mostly by the memory 14.

### 2-1. Setting Information Memory

The setting information memory 50 stores identification information relating to a communication device (such as the DHCP server 32 or 42) connected to each network (such as the first network 30 or the second network 40) and network setting information corresponding to the network in association with each other. In the exemplary embodiment, the identifier of each of the DHCP servers 32 and 42 (such as the name, media access control (MAC) address, or vendor unique information of each server) corresponds to the identification information.

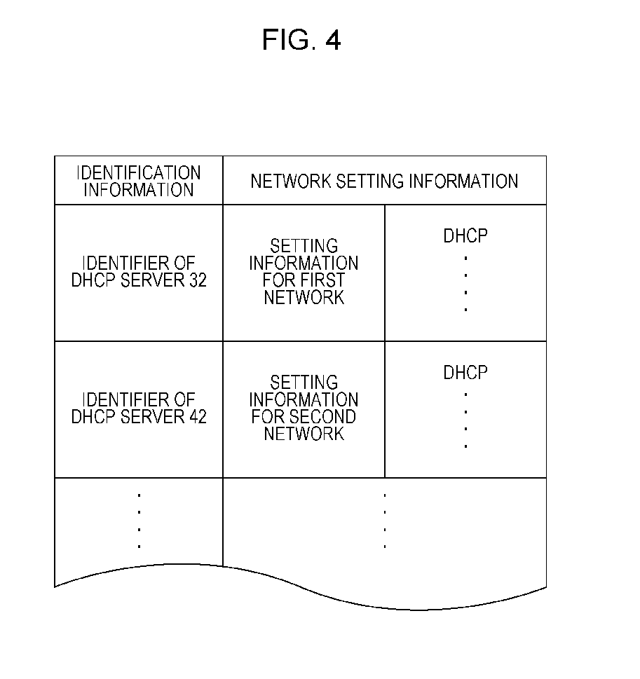

FIG. 4 is a diagram illustrating exemplary details stored in the setting information memory 50. As illustrated in FIG. 4, the identifier of the DHCP server 32 and network setting information for the first network 30 to which the DHCP server 32 is connected are stored in association with each other, and the identifier of the DHCP server 42 and network setting information for the second network 40 to which the DHCP server 42 is connected are stored in association with each other. The identifiers of the DHCP servers 32 and 42 stored in the setting information memory 50 may be obtained in communication performed in the past, or may be input from a user.

The network setting information is information set in the first physical interface 22 or the second physical interface 24. The network setting information is information that defines the details of communication (communication method) to be performed by the first physical interface 22 or the second physical interface 24. For example, the network setting information is information indicating the presence of DHCP setting, information indicating whether to use the Internet Protocol version 4 (IPv4) (whether to turn on/off IPv4), information indicating whether to use the Internet Protocol version 6 (IPv6) (whether to turn on/off IPv6), and the like. Parameters included in the network setting information are set in advance by the user.

Alternatively, for example, when the first network 30 or the second network 40 is an NGN, the network setting information may include session initiation protocol facsimile (SIP FAX) information, the IP address of a home gateway of the NGN (a device corresponding to a broadband router of the NGN), or the like. The SIP FAX information is setting information in the T.38 protocol, which is a communication protocol used in SIP FAX. The SIP FAX information is, for example, a port number used in T.38 communication. Alternatively, for example, the IP address of a home gateway of the NGN (a device corresponding to a broadband router of the NGN) may correspond to setting information unique to the first network 30.

Any of the pieces of network setting information stored in the setting information memory 50 is set in each of the multiple physical interfaces included in the image forming apparatus 10 (here, the first physical interface 22 and the second physical interface 24). Associating (connecting) each of the first physical interface 22 and the second physical interface 24 with a first logic interface 58 or a second logic interface 60, which are described later, corresponds to setting network setting information in each of the first physical interface 22 and the second physical interface 24.

The first physical interface 22 and the second physical interface 24 perform communication on the basis of the network setting information set therein. For example, when DHCP is set in the network setting information, the first physical interface 22 and the second physical interface 24 broadcast a discover message in response to detection of insertion of the cables 34 and 44 into the first physical interface 22 and the second physical interface 24.

### 2-2. Communication Details Obtaining Unit

The communication details obtaining unit 52 obtains the details of communication (packets) between the image forming apparatus 10 and another computer. Here, the communication details obtaining unit 52 obtains information (offer messages and the like) sent by the DHCP servers 32 and 42. It is assumed that the details of communication obtained by the communication details obtaining unit 52 include the identifiers of the DHCP servers 32 and 42. The identifiers of the DHCP servers 32 and 42 are included in offer messages, and, for example, the names or MAC addresses of the DHCP servers 32 and 42 correspond to the identifiers.

### 2-3. Identification Information Determining Unit

On the basis of the result of obtaining performed by the communication details obtaining unit 52, the identification information determining unit 54 determines whether identification information (such as the identifier of the DHCP server 32 or 42) obtained via each of the physical interfaces (here, the first physical interface 22 and the second physical interface 24) and identification information associated with network setting information set in the physical interface match each other (or differ from each other).

The identification information determining unit 54 compares the identifier of the DHCP server 32 or 42 and the identifier stored in the setting information memory 50 and determines whether the two identifiers are the same (or different). For example, the identification information determining unit 54 compares a character string of the identifier obtained by the communication details obtaining unit 52 and a character string of the identifier stored in the setting information memory 50 and determines whether the two identifiers match each other (or differ from each other).

### 2-4. Communication Controller

When identification information (such as the identifier of the DHCP server 32 or 42) obtained via a physical interface (such as the first physical interface 22 or the second physical interface 24) is different from identification information associated with network setting information set in the physical interface, the communication controller 56 controls communication of the physical interface on the basis of network setting information associated with the obtained identification information.

When the identification information determining unit 54 determines that the two pieces of identification information do not match each other (the two pieces of identification information are different), the communication controller 56 sets, instead of the network setting information currently set in the first physical interface 22 or the second physical interface 24, network setting information associated with the above-obtained identifier of the DHCP server 32 or 42 in the physical interface. That is, the communication controller 56 changes the network setting information set in the first physical interface 22 or the second physical interface 24.

Here, the communication controller 56 includes multiple logic interfaces (such as the first logic interface 58 and the second logic interface 60).

The first logic interface 58 is a logic interface for setting network setting information for the first network 30, and obtains network setting information associated with the identifier of the DHCP server 32 connected to the first network 30. The first logic interface 58 controls communication of a physical interface on the basis of this network setting information.

In contrast, the second logic interface 60 is a logic interface for setting network setting information for the second network 40, and obtains network setting information associated with the identifier of the DHCP server 42 connected to the second network 40. The second logic interface 60 controls communication of a physical interface on the basis of this network setting information.

In the exemplary embodiment, when identification information (such as the identifier of the DHCP server 32 or 42) obtained via at least one of multiple physical interfaces (such as the first physical interface 22 and the second physical interface 24) is different from identification information associated with network setting information set in the physical interface, the communication controller 56 controls the relationship between each of the multiple physical interfaces and network setting information set in a memory (such as the setting information memory 50).

The relationship between each of the first physical interface 22 and the second physical interface 24 and the network setting information is association (mapping) between each of the first physical interface 22 and the second physical interface 24 with one of the first logic interface 58 and the second logic interface 60. Controlling the relationship corresponds to switching (changing) the combination of a physical interface and a logic interface.

For example, when the first physical interface 22 is associated with the first logic interface 58 and when the second physical interface 24 is associated with the second logic interface 60, the communication controller 56 performs control to associate the second logic interface 60 with the first physical interface 22 and to associate the first logic interface 58 with the second physical interface 24.

Alternatively, when the first physical interface 22 is associated with the second logic interface 60 and when the second physical interface 24 is associated with the first logic interface 58, the communication controller 56 performs control to associate the first logic interface 58 with the first physical interface 22 and to associate the second logic interface 60 with the second physical interface 24.

### 3. Process Executed by Image Forming Apparatus

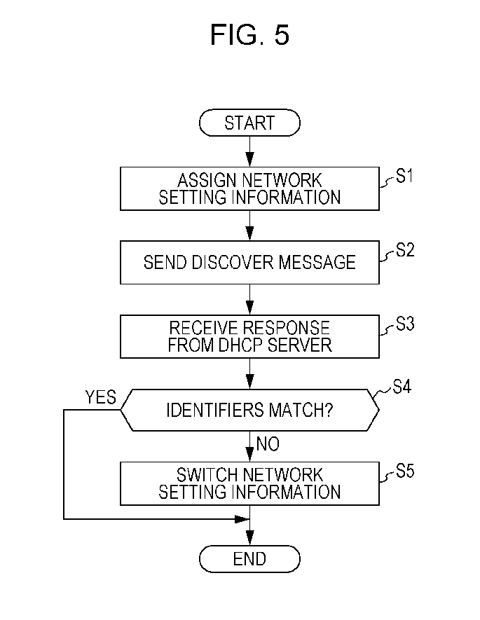

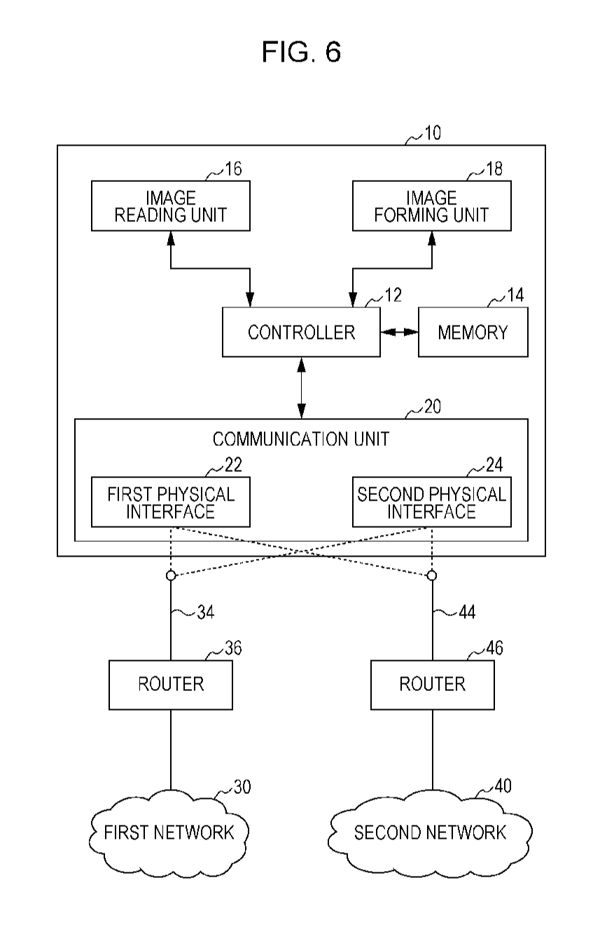

FIG. 5 is a flowchart illustrating a process executed by the image forming apparatus 10. In accordance with the program stored in the memory 14, the controller 12 executes the process illustrated in FIG. 5. In response to execution of the process illustrated in FIG. 5, the functions illustrated in FIG. 3 are realized in the image forming apparatus 10. Here, the case in which the following process is executed when the power switch of the image forming apparatus 10 is turned on will be described. It is also assumed that this process is executed in a state where the cables 34 and 44 are inserted into the first physical interface 22 and the second physical interface 24 either respectively or vice versa.

As illustrated in FIG. 5, on the basis of a default setting stored in the memory 14, the controller 12 assigns network setting information to the first physical interface 22 and the second physical interface 24 (S1). In step S1, the controller 12 determines the association between each of the first physical interface 22 and the second physical interface 24 with each piece of network setting information. That is, the controller 12 connects each of the first physical interface 22 and the second physical interface 24 with either of the first physical interface 22 and the second physical interface 24. It is assumed that the default setting is stored in advance in the memory 14. For example, the association at the time the power switch was previously turned off corresponds to the default setting.

On the basis of the default setting, the controller 12 sends a discover message to either of the DHCP server 32 and the DHCP server 42 via each of the first physical interface 22 and the second physical interface 24 (S2). In step S2, the discover message is broadcast.

The controller 12 receives a response from the DHCP server 32 or the DHCP server 42 (S3). Here, the controller 12 obtains an offer message from the DHCP server 32 and an offer message from the DHCP server 42. These offer messages include the identifiers of the DHCP servers 32 and 42.

The controller 12 determines whether the identifier included in each of the offer messages obtained in step S3 and an identifier associated with network setting information set in each of the first physical interface 22 and the second physical interface 24 match each other (S4). In step S4, the controller 12 compares the character strings of the identifiers of the DHCP servers 32 and 42.

When the controller 12 determines that the identifiers do not match each other (S4; N), the controller 12 switches the network setting information in the first physical interface 22 and the second physical interface 24. In step S5, the controller 12 changes, from the default setting, the combination of each of the first physical interface 22 and the second physical interface 24 with either of the first logic interface 58 and the second logic interface 60.

When the controller 12 determines that the identifiers match each other (S4; Y), processing in step S5 is not executed, and this process ends. In this case, a process of changing the network setting information is not executed since each of the first physical interface 22 and the second physical interface 24 is connected to a network that fits the default setting.

The above-described image forming apparatus 10 performs communication using network setting information that fits a network connected to the image forming apparatus 10. Also, the image forming apparatus 10 controls the association between each of multiple physical interfaces and network setting information. Also, the image forming apparatus 10 specifies network setting information to be set, on the basis of the identification information of the DHCP servers 32 and 42.

### 4. Modifications

The exemplary embodiment of the invention is not limited to that described above and is appropriately changeable without departing from the scope thereof.

(1) For example, the accuracy of mapping the physical interfaces to the logic interfaces may be increased by comparing the identifier of the DHCP server 32 or 42, obtained by the first physical interface 22 or the second physical interface 24, with, among identifiers stored in the setting information memory 50, an identifier other than that associated with the first physical interface 22 or the second physical interface 24.

The identification information determining unit 54 in the modification (1) determines whether identification information (such as the identifier of the DHCP server 32 or 42) obtained via a physical interface (such as the first physical interface 22 or the second physical interface 24) and identification information associated with network setting information other than that set in the physical interface match each other.

When identification information (such as the identifier of the DHCP server 32 or 42) obtained via a physical interface (such as the first physical interface 22 or the second physical interface 24) is different from identification information associated with network setting information set in the physical interface, and when the obtained identification information matches identification information associated with other network setting information, the communication controller 56 controls communication of the physical interface on the basis of this other network setting information. That is, the communication controller 56 sets, among pieces of network setting information stored in the setting information memory 50, network setting information associated with an identifier determined, by the identification information determining unit 54, to match the obtained identification information in the first physical interface 22 or the second physical interface 24.

According to the modification (1), communication is performed using network setting information associated with identification information that matches identification information obtained via a physical interface.

(2) In step S4 in the exemplary embodiment, whether the identifiers of the first physical interface 22 or the second physical interface 24 match each other is determined. Alternatively, the mapping accuracy may be increased by determining whether the identifiers of both the first physical interface 22 and the second physical interface 24 match each other.

The identification information determining unit 54 in the modification (2) determines, for each of multiple physical interfaces (such as the first physical interface 22 and the second physical interface 24), whether identification information (such as the identifier of the DHCP server 32 or 42) obtained via the physical interface and identification information associated with network setting information set in the physical interface match each other.

For each of multiple physical interfaces (such as the first physical interface 22 and the second physical interface 24), when identification information (such as the identifier of the DHCP server 32 or 42) obtained via the physical interface is different from identification information associated with network setting information set in the physical interface, the communication controller 56 controls the relationship between each of the physical interfaces and network setting information set in a memory (such as the setting information memory 50). That is, when the identifiers of both the first physical interface 22 and the second physical interface 24 are determined not to match each other, the communication controller 56 changes the mapping of the physical interfaces to the logic interfaces.

According to the modification (2), the association of each of multiple physical interfaces with network setting information is controlled in accordance with identification information relating to a communication device, which is obtained via the physical interface.

(3) For example, when multiple DHCP servers are connected to each network, in response to a discover message sent to the image forming apparatus 10, responses may be received from these DHCP servers. Therefore, the identifier of each of the DHCP servers may be stored in the setting information memory 50.

In the setting information memory 50 in the modification (3), identification information of each of the DHCP servers is associated with network setting information. Each of these pieces of identification information is identification information obtained in the case where the first network 30 or the second network 40 was connected to the image forming apparatus 10 in the past.

The identification information determining unit 54 determines whether identification information of a DHCP server (such as the identifier of the DHCP server 32 or 42), obtained via a physical interface (such as the first physical interface 22 or the second physical interface 24), matches any of pieces of identification information associated with network setting information set in the physical interface. The identification information determining unit 54 performs comparison of each of these pieces of identification information stored in the setting information memory 50.

When identification information of a DHCP server (such as the identifier of the DHCP server 32 or 42), obtained via a physical interface (such as the first physical interface 22 or second physical interface 24), is different from identification information of the DHCP server, associated with network setting information set in the physical interface, the communication controller 56 controls communication of the physical interface on the basis of network setting information associated with the above-obtained identification information of the DHCP server. That is, when it is determined that the obtained identification information does not match any of identifiers associated with network setting information currently set in the first physical interface 22 or the second physical interface 24, the communication controller 56 changes the mapping of the physical interfaces to the logic interfaces.

According to the modification (3), network setting information to be set is specified on the basis of identification information of multiple DHCP servers.

(4) For example, information other than a DHCP identifier may correspond to identification information of a communication device. For example, if no DHCP server exists in the NGN, an IP address may be obtained on the basis of information obtained from a router. Therefore, information obtained from the router may correspond to identification information of a communication device.

FIG. 6 is a hardware block diagram according to the modification (4). As illustrated in FIG. 6, a router 36 is connected to the first network 30, and a router 46 is connected to the second network 40. In response to a request from the image forming apparatus 10, the routers 36 and 46 send the prefix of a stateless address. The prefix of a stateless address is different for each of the routers 36 and 46.

On the basis of the prefix of a stateless address obtained from the router 36 or the router 46 and the MAC address of the image forming apparatus 10 (such as the MAC address of the first physical interface 22 or the second physical interface 24), the image forming apparatus 10 obtains an IP address in the IPv6 format. For example, when the length of an IP address in the IPv6 format is 128 bits, the prefix of the stateless address (identification information of the router 36 or 46) is used as the most significant 64 bits, and the MAC address of the image forming apparatus 10 (identifier of the image forming apparatus 10) is used as the least significant 64 bits.

The setting information memory 50 in the modification (4) stores, as identification information, identification information (such as the prefix of a stateless address) relating to the router 36 or 46. It is also assumed that the identification information includes information indicating whether to automatically set the stateless address, that is, information indicating whether the image forming apparatus 10 generates an IP address without using DHCP.

The identification information determining unit 54 compares and determines whether the prefix of a stateless address of the router 36 or 46 obtained via the first physical interface 22 or the second physical interface 24 and the prefix of a stateless address stored in the setting information memory 50 match each other (or differ from each other).

When identification information (such as the prefix of a stateless address) relating to the router 36 or 46, obtained via a physical interface (such as the first physical interface 22 or the second physical interface 24), is different from identification information relating to the router, associated with network setting information set in the physical interface, the communication controller 56 controls communication of the physical interface on the basis of network setting information associated with the above-obtained identification information of the router. A method for controlling the communication is the same as or similar to that in the exemplary embodiment or other modifications.

According to the modification (4), network setting information to be set is specified on the basis of identification information relating to the router 36 or 46.

(5) When a network connected to the image forming apparatus 10 is an NGN, vendor information (vendor-identifying vendor specific information) may be used as the identifier of a DHCP server. The vendor information includes a vendor identifier that identifies the provider of the NGN and vendor definition information indicating setting information set by each provider.

For example, the above-described modifications may be combined. Further, only one physical interface may be included in the image forming apparatus 10. Also, for example, the information processing apparatus according to the exemplary embodiment of the invention is applicable to a computer different from the image forming apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a physical interface that communicates with any of a plurality of networks;
a memory that stores identification information relating to a communication device connected to each network and network setting information corresponding to the network in association with each other; and
a communication controller that controls, when identification information obtained via the physical interface is different from identification information associated with network setting information set in the physical interface, communication of the physical interface on the basis of network setting information associated with the obtained identification information.

2. The information processing apparatus according to claim 1,
wherein the physical interface comprises a plurality of physical interfaces,
wherein any of the network setting information, stored in the memory, is set in each of the plurality of physical interfaces, and
wherein, when identification information obtained via at least one of the plurality of physical interfaces is different from identification information associated with network setting information set in the physical interface, the communication controller controls the relationship between each of the plurality of physical interfaces and the network setting information stored in the memory.

3. The information processing apparatus according to claim 1,
wherein, when identification information obtained via the physical interface is different from identification information associated with network setting information set in the physical interface, and when the obtained identification information matches identification information associated with other network setting information, the communication controller controls communication of the physical interface on the basis of the other network setting information.

4. The information processing apparatus according to claim 2,
wherein, when identification information obtained via the physical interface is different from identification information associated with network setting information set in the physical interface, and when the obtained identification information matches identification information associated with other network setting information, the communication controller controls communication of the physical interface on the basis of the other network setting information.

5. The information processing apparatus according to claim 1,
wherein the physical interface comprises a plurality of physical interfaces,
wherein any of the network setting information, stored in the memory, is set in each of the plurality of physical interfaces, and
wherein, for each of the plurality of physical interfaces, when identification information obtained via the physical interface is different from identification information associated with network setting information set in the physical interface, the communication controller controls the relationship between each of the plurality of physical interfaces and the network setting information stored in the memory.

6. The information processing apparatus according to claim 2,
wherein the physical interface comprises a plurality of physical interfaces,
wherein any of the network setting information, stored in the memory, is set in each of the plurality of physical interfaces, and
wherein, for each of the plurality of physical interfaces, when identification information obtained via the physical interface is different from identification information associated with network setting information set in the physical interface, the communication controller controls the relationship between each of the plurality of physical interfaces and the network setting information stored in the memory.

7. The information processing apparatus according to claim 3,
wherein the physical interface comprises a plurality of physical interfaces,
wherein any of the network setting information, stored in the memory, is set in each of the plurality of physical interfaces, and
wherein, for each of the plurality of physical interfaces, when identification information obtained via the physical interface is different from identification information associated with network setting information set in the physical interface, the communication controller controls the relationship between each of the plurality of physical interfaces and the network setting information stored in the memory.

8. The information processing apparatus according to claim 4,
wherein the physical interface comprises a plurality of physical interfaces,
wherein any of the network setting information, stored in the memory, is set in each of the plurality of physical interfaces, and
wherein, for each of the plurality of physical interfaces, when identification information obtained via the physical interface is different from identification information associated with network setting information set in the physical interface, the communication controller controls the relationship between each of the plurality of physical interfaces and the network setting information stored in the memory.

9. The information processing apparatus according to claim 1,
wherein the communication device is a Dynamic Host Configuration Protocol (DHCP) server,
wherein identification information of the DHCP server connected to each network and network setting information corresponding to the network are associated with each other in the memory, and
wherein, when identification information of the DHCP server, obtained via the physical interface, is different from identification information of the DHCP server, associated with network setting information set in the physical interface, the communication controller controls communication of the physical interface on the basis of network setting information associated with the obtained identification information of the DHCP server.

10. The information processing apparatus according to claim 9,
wherein a plurality of DHCP servers are connected to each of the plurality of networks,
wherein identification information of each of the plurality of DHCP servers and network setting information are associated with each other in the memory, and
wherein, when identification information of a DHCP server, obtained via the physical interface, is different from the pieces of identification information of the plurality of DHCP servers, associated with network setting information set in the physical interface, the communication controller controls communication of the physical interface on the basis of network setting information associated with the obtained identification information of the DHCP server.

11. The information processing apparatus according to claim 1,
wherein the communication device is a router,
wherein identification information relating to the router connected to each network and network setting information corresponding to the network are associated with each other in the memory, and
wherein, when identification information relating to the router, obtained via the physical interface, is different from identification information relating to the router, associated with network setting information set in the physical interface, the communication controller controls communication of the physical interface on the basis of network setting information associated with the obtained identification information.

12. A non-transitory computer readable medium storing a program causing a computer to execute a process, the process comprising:
obtaining details stored in a memory that stores identification information relating to a communication device connected to each of a plurality of networks and network setting information corresponding to the network in association with each other; and
controlling, when identification information obtained via a physical interface is different from identification information associated with network setting information set in the physical interface, communication of the physical interface on the basis of network setting information associated with the obtained identification information.

13. An image processing method comprising:
obtaining details stored in a memory that stores identification information relating to a communication device connected to each of a plurality of networks and network setting information corresponding to the network in association with each other; and
controlling, when identification information obtained via a physical interface is different from identification information associated with network setting information set in the physical interface, communication of the physical interface on the basis of network setting information associated with the obtained identification information.
